(19) United States
(12) Patent Application Publication
(10) Pub. No.: US 2016/0208974 A1
(43) Pub. Date: Jul. 21, 2016

(54) MULTISTAGE PRESSURE REDUCTION DEVICE AND BOILER

(71) Applicant: MITSUBISHI HITACHI POWER SYSTEMS, LTD., Kanagawa (JP)

(72) Inventors: Naoki SUGANUMA, Tokyo (JP); Takahiro OKIMOTO, Tokyo (JP); Tetsuya YAMADA, Tokyo (JP); Noboru KAWAMOTO, Tokyo (JP); Shun YAMANOUCHI, Tokyo (JP)

(21) Appl. No.: 15/024,679

(22) PCT Filed: Aug. 14, 2014
(86) PCT No.: PCT/JP2014/071440

§ 371 Date: Mar. 24, 2016

(30) Foreign Application Priority Data
Oct. 31, 2013 (JP) 2013-226928

(51) Int. Cl. F16L 55/027; F23K 5/00

(52) U.S. Cl. CPC F16L 55/02718; F23K 5/00

(57) ABSTRACT

A multistage pressure reduction device (10) of the present invention includes a fuel pipe (1) forming a flow path (5), an upstream orifice plate (2) disposed in the flow path (5), and a downstream orifice plate (3) disposed downstream of the upstream orifice plate (2) in the flow path (5). The upstream orifice plate (2) is formed such that a jet flow (7-i) discharged from a hole (6-i) formed at the upstream orifice plate (2) contacts a certain target. With this multistage pressure reduction device (10), the jet flow (7-i) discharged from the upstream orifice plate (2) contacts the certain target to prevent air column resonance excited between the upstream orifice plate (2) and the downstream orifice plate (3). Noise due to the air column resonance can be reduced without providing a porous metal between the upstream orifice plate (2) and the downstream orifice plate (3).

### TECHNICAL FIELD

The present invention relates to a multistage pressure reduction device and a boiler.

### BACKGROUND ART

A boiler has been known, which is configured to use heat obtained by fuel combustion to heat water. In the boiler, a multistage pressure reduction device configured to reduce the pressure of fuel is provided at a fuel supply flow path for supplying the fuel from a fuel supply source to a burner. It is desired for the multistage pressure reduction device to reduce noise.

Japanese Unexamined Patent Application, Publication No. Sho 60-60304 discloses a low-noise low-vibration pressure reduction device. Such a device is configured such that a plurality of metal meshes formed by normal temperature expansion cutting are disposed at a liquid delivery piping system, and are arranged across the entire cross section of a pipe line formed with a raised-recessed portion forming a waveform in the longitudinal direction of the pipe line.

Japanese Unexamined Utility Model Application, Publication No. Hei 4-25094 discloses a low-noise multistage pressure reduction device. Such a device includes a plurality of porous orifice plates arranged at a predetermined interval from an upstream side to a downstream side in a flow path, and porous metals each interposed between adjacent ones of the porous orifice plates.

### CITATION LIST

### Patent Literature

### {PTL 1}

Japanese Unexamined Patent Application, Publication No. Sho 60-60304

### {PTL 2}

Japanese Unexamined Utility Model Application, Publication No. Hei 4-25094

### SUMMARY OF INVENTION

### Technical Problem

For a multistage pressure reduction device, proper noise reduction is desired. It is also desired to reduce noise without providing a metal mesh or a porous metal on the downstream side of an orifice plate.

The present invention is intended to provide a multistage pressure reduction device configured to reduce noise without providing a porous metal between an upstream orifice plate and a downstream orifice plate and to provide a boiler.

### Solution to Problem

A multistage pressure reduction device of a first aspect of the present invention includes a pipe forming a flow path, an upstream orifice plate disposed in the flow path, and a downstream orifice plate disposed downstream of the upstream orifice plate in the flow path. The upstream orifice plate is formed to cause contact of a jet flow discharged from a hole formed at the upstream orifice plate.

With such a multistage pressure reduction device, contact of the jet flow discharged from the upstream orifice plate can prevent air column resonance excited between the upstream orifice plate and the downstream orifice plate, leading to reduction in noise due to the air column resonance.

Another hole may be further formed at the upstream orifice plate, and the upstream orifice plate may be formed such that the jet flow contacts another jet flow discharged from the other hole.

With such a multistage pressure reduction device, the plurality of jet flows discharged respectively from the plurality of holes formed at the upstream orifice plate contact each other. Thus, the air column resonance excited between the upstream orifice plate and the downstream orifice plate can be prevented, leading to reduction in noise due to the air column resonance.

The hole may be formed in a polygonal shape. With such a multistage pressure reduction device, the plurality of jet flows discharged respectively from the plurality of holes formed at the upstream orifice plate can properly contact each other. Thus, the air column resonance excited between the upstream orifice plate and the downstream orifice plate can be properly prevented.

The upstream orifice plate may be formed such that the jet flow contacts an inner wall of the pipe. With such a multistage pressure reduction device, the jet flow discharged from the upstream orifice plate contacts the inner wall of the pipe. Thus, the air column resonance excited between the upstream orifice plate and the downstream orifice plate can be prevented, leading to reduction in noise due to the air column resonance.

Another hole may be further formed at the upstream orifice plate, and the upstream orifice plate may be formed such that other jet flow discharged from the other hole contacts the inner wall. With such a multistage pressure reduction device, the plurality of jet flows discharged respectively from the plurality of holes formed at the upstream orifice plate contact the inner wall of the pipe. Thus, the air column resonance excited between the upstream orifice plate and the downstream orifice plate can be prevented, leading to reduction in noise due to the air column resonance.

A burner of a second aspect of the present invention includes the multistage pressure reduction device of the present invention, and a burner configured to burn fuel whose pressure is reduced by the multistage pressure reduction device. In such a boiler, the multistage pressure reduction device can prevent the air column resonance to reduce noise generation.

### Advantageous Effects of Invention

The multistage pressure reduction device and the boiler according to the present invention cause contact of the jet flow(s) discharged from the upstream orifice plate to prevent the air column resonance excited between the upstream orifice plate and the downstream orifice plate. As a result, noise can be reduced.

### BRIEF DESCRIPTION OF DRAWINGS

FIG. 1 is a cross-sectional view of a multistage pressure reduction device.

FIG. 2 is a plan view of a first-stage orifice plate.

FIG. 3 is a plan view of a second-stage orifice plate.

FIG. 4 is a plan view of another first-stage orifice plate.

FIG. 5 is a cross-sectional view of another multistage pressure reduction device.

### DESCRIPTION OF EMBODIMENTS

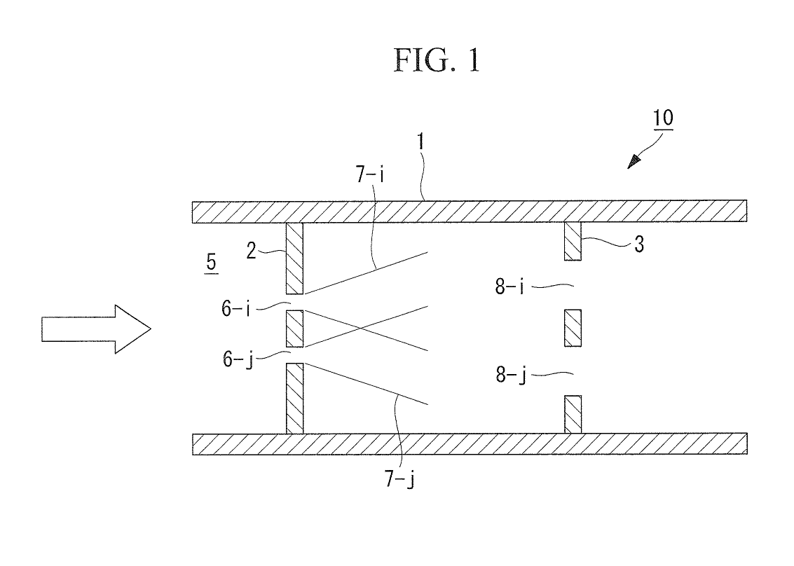

An embodiment of a multistage pressure reduction device will be described below with reference to drawings. A multistage pressure reduction device 10 includes, as illustrated in FIG. 1, a fuel pipe 1, a first-stage orifice plate 2, and a second-stage orifice plate 3. The fuel pipe 1 is formed in a tubular shape, and has a flow path 5 formed therein. The first-stage orifice plate 2 is formed in a discoid shape, and is disposed to close the flow path 5. The second-stage orifice plate 3 is formed in a discoid shape, and is disposed to close downstream of the first-stage orifice plate 2 in the flow path 5.

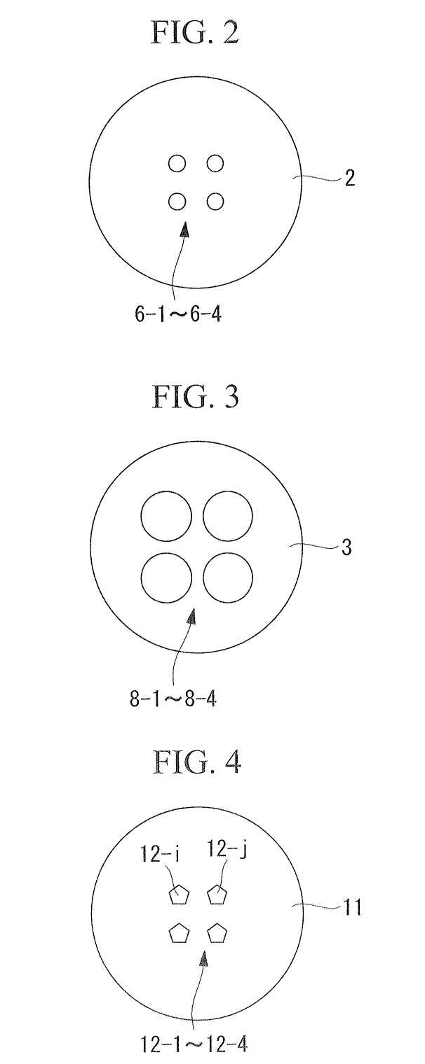

The first-stage orifice plate 2 is formed with a plurality of holes 6-1 to 6-4. As illustrated in FIG. 2, the holes 6-1 to 6-4 are formed such that the distance between adjacent hole centers is set at the minimum distance being equal to or longer than 1d and maintaining rigidity, where “d” denotes a hole diameter. The diameter of each of the holes 6-1 to 6-4 is designed such that the opening area of a single hole designed based on the difference in pressure to be reduced by the multistage pressure reduction device 10 and the opening area of the holes 6-1 to 6-4 are equal to each other. Further, the first-stage orifice plate 2 is formed such that the holes 6-1 to 6-4 are close to each other with a predetermined distance.

The second-stage orifice plate 3 is formed with a plurality of holes 8-1 to 8-4. As illustrated in FIG. 3, the holes 8-1 to 8-4 are each formed in a circular shape having a predetermined diameter. Such a diameter is designed such that the opening area of a single hole designed based on the difference in pressure to be reduced by the multistage pressure reduction device 10 and the opening area of the holes 8-1 to 8-4 are equal to each other and that the opening area of the holes 8-1 to 8-4 is larger than that of the holes 6-1 to 6-4 formed at the first-stage orifice plate 2.

The multistage pressure reduction device 10 is used for a boiler. The boiler includes a burner, and uses the fuel pipe 1 to supply fuel from a fuel supply source to the burner. The fuel first flows through the flow path 5 of the fuel pipe 1 to pass through the holes 6-1 to 6-4 of the first-stage orifice plate 2. Since the fuel passes through the holes 6-1 to 6-4, the first-stage orifice plate 2 generates, as illustrated in FIG. 1, a plurality of jet flows of the fuel discharged respectively from the holes 6-1 to 6-4 in the flow path 5. These jet flows include a jet flow 7-i discharged from any hole 6-i (i=1, 2, 3, 4) of the holes 6-1 to 6-4, and a jet flow 7-j discharged from another hole 6-j (j=1, 2, 3, 4 and j≠i) different from the hole 6-i of the holes 6-1 to 6-4. In this state, the jet flow 7-i contacts the jet flow j. That is, in the first-stage orifice plate 2, the holes 6-1 to 6-4 are close to each other such that the jet flow 7-i contacts the jet flow 7-j and that the jet flows discharged respectively from the holes 6-1 to 6-4 contact each other.

After passing through the holes 6-1 to 6-4 of the first-stage orifice plate 2, the fuel passes through the holes 8-1 to 8-4 of the second-stage orifice plate 3, and then, is supplied to the burner. The burner burns the fuel supplied through the fuel pipe 1, and the boiler uses combustion heat of the fuel to heat water.

The multistage pressure reduction device 10 is configured such that the first-stage orifice plate 2 is formed with the holes 6-1 to 6-4 having the predetermined opening area and that the second-stage orifice plate 3 is formed with the holes 8-1 to 8-4 having the predetermined opening area. With this configuration, the pressure of fuel flowing downstream of the second-stage orifice plate 3 in the flow path 5 can be reduced to a proper pressure. As a result, the fuel pipe 1 can properly supply the fuel to the burner. The burner can properly burn the fuel. The boiler can properly heat water.

A multistage pressure reduction device of a comparative example is configured such that the first-stage orifice plate 2 of the multistage pressure reduction device 10 of the above-described embodiment is replaced with another first-stage orifice plate. The first-stage orifice plate is formed with a single hole. In the multistage pressure reduction device of the comparative example, air column resonance of a frequency f represented by the following expression is excited between the first-stage orifice plate and the second-stage orifice plate 3:

f=St·V/(I+h)

As a result, noise is generated. In the expression, “St” denotes the Strouhal number of the air column resonance, “V” denotes the flow velocity of fuel in the flow path 5, “I” denotes an orifice interval between the first-stage orifice plate and the second-stage orifice plate, and “h” denotes the thickness of the first-stage orifice plate.

The multistage pressure reduction device 10 can prevent the air column resonance generation in such a manner that the jet flows generated from the first-stage orifice plate 2 contact each other. The noise due to the air column resonance can be reduced without providing a porous metal between the first-stage orifice plate 2 and the second-stage orifice plate 3.

In another embodiment of the multistage pressure reduction device, the first-stage orifice plate 2 of the above-described embodiment is replaced with another first-stage orifice plate. A first-stage orifice plate 11 is formed with a plurality of holes 12-1 to 12-4 as illustrated in FIG. 4. The holes 12-1 to 12-4 are each formed in a pentagonal shape. In the first-stage orifice plate 11, the holes 12-1 to 12-4 are close to each other such that a plurality of jet flows discharged respectively from the holes 12-1 to 12-4 contact each other.

The multistage pressure reduction device including the first-stage orifice plate 11 is, as in the multistage pressure reduction device 10 of the above-described embodiment, configured such that the jet flows generated by the first-stage orifice plate 11 contact each other. This can prevent the air column resonance generated between the first-stage orifice plate 11 and the second-stage orifice plate 3. As a result, the noise due to the air column resonance can be reduced.

Further, the multistage pressure reduction device including the first-stage orifice plate 11 is configured such that the holes 12-1 to 12-4 are formed in the pentagonal shape. Thus, as compared to the multistage pressure reduction device 10 of the above-described embodiment, the jet flows generated by the first-stage orifice plate 11 can more properly contact each other. As a result, the noise due to the air column resonance can be more properly reduced.

The holes 12-1 to 12-4 can be formed in another polygonal shape different from the pentagonal shape, and for example, can be formed in a triangular shape. Similarly, in the multistage pressure reduction device including the first-stage orifice plate formed with the polygonal holes, the jet flows generated by the first-stage orifice plate can more properly contact each other. As a result, the noise due to the air column resonance can be more properly reduced.

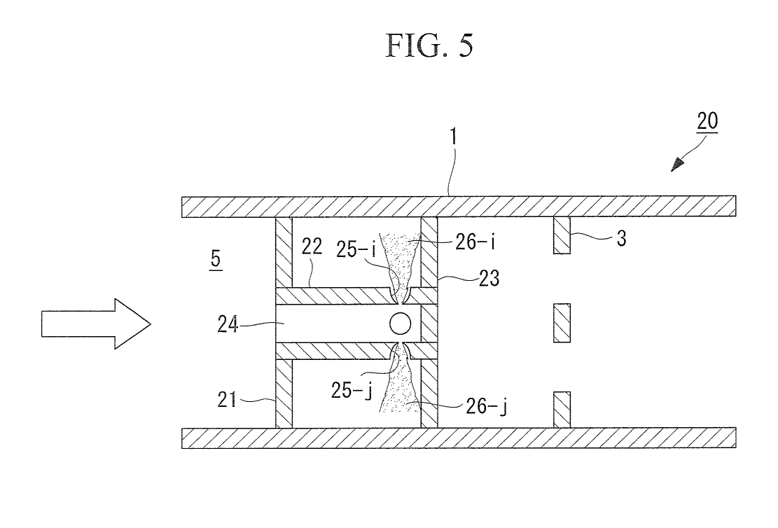

FIG. 5 illustrates another embodiment of the multistage pressure reduction device. A multistage pressure reduction device 20 is configured such that the first-stage orifice plate 2 of the multistage pressure reduction device 10 of the above-described embodiment is replaced with a first-stage orifice plate 21, a cylinder 22, and a support member 23. The first-stage orifice plate 21 is formed in a discoid shape, and is disposed to close a flow path 5. A hole 24 is formed at the center of the first-stage orifice plate 21.

The cylinder 22 is formed in a tubular shape, and is disposed at the center of the flow path 5. One end of the cylinder 22 is closed, and the other end of the cylinder 22 is joined to the first-stage orifice plate 21 such that the hole 24 of the first-stage orifice plate 21 is connected to the inside of the cylinder 22. The cylinder 22 is further formed with a plurality of holes. Any hole 25-i of these holes is formed such that a jet flow 26-i is discharged from the inside to the outside of the cylinder 22 through the hole 25-i in the direction perpendicular to the longitudinal direction of a fuel pipe 1 and that the jet flow 26-i discharged from the inside to the outside of the cylinder 22 through the hole 25-i contacts an inner wall of the fuel pipe 1. The holes are formed such that the opening area thereof is equal to the opening area of a single hole designed based on the difference in pressure to be reduced by the multistage pressure reduction device 20. The support member 23 includes a plurality of rod-shaped members, and an end of each member close to the closed end of the cylinder 22 is fixed to the inner wall of the fuel pipe 1.

The multistage pressure reduction device 20 uses the fuel pipe 1 to supply fuel from a fuel supply source to a burner. The fuel first flows through the flow path 5 of the fuel pipe 1 to pass through the hole 24 of the first-stage orifice plate 21, and then, flows into the cylinder 22. Since the fuel flows into the cylinder 22, the cylinder 22 discharges the fuel through the holes formed at the cylinder 22 to generate a plurality of jet flows contacting the inner wall of the fuel pipe 1. After contacting the inner wall of the fuel pipe 1, the fuel flows toward a second-stage orifice plate 3 in the flow path 5, and then, passes through a plurality of holes 8-1 to 8-4 of the second-stage orifice plate 3.

The cylinder 22 of the multistage pressure reduction device 20 is formed with the holes having a predetermined opening area, and the second-stage orifice plate 3 is formed with the holes 8-1 to 8-4 having a predetermined opening area. Thus, the pressure of fuel flowing through the fuel pipe 1 can be properly reduced, and the fuel can be supplied to the burner with a proper pressure.

In the multistage pressure reduction device 20, the jet flows discharged from the holes formed at the cylinder 22 contact the inner wall of the fuel pipe 1. This can prevent air column resonance generated between the first-stage orifice plate 21 and the second-stage orifice plate 3 without the jet flows 26-i, 26-j discharged from the holes 25-i, 25-j contacting each other. As a result, noise due to the air column resonance can be reduced without providing a porous metal between the first-stage orifice plate 21 and the second-stage orifice plate 3.

The cylinder 22 can be replaced with another cylinder configured to discharge a jet flow in another direction different from the direction perpendicular to the longitudinal direction of the fuel pipe 1 to cause such a jet flow to contact the inner wall of the fuel pipe 1. In a multistage pressure reduction device including such a cylinder, a plurality of jet flows discharged from the cylinder 22 contact, as in the above-described multistage pressure reduction device 20, the inner wall of the fuel pipe 1 so that air column resonance generated between the first-stage orifice plate 21 and the second-stage orifice plate 3 can be prevented. As a result, noise due to the air column resonance can be reduced.

The cylinder 22 can be replaced with still another cylinder formed only with a single hole through which a jet flow is discharged to contact the inner wall of the fuel pipe 1. In a multistage pressure reduction device including such a cylinder, the jet flow discharged from the cylinder 22 contacts, as in the above-described multistage pressure reduction device 20, the inner wall of the fuel pipe 1 so that air column resonance generated between the first-stage orifice plate 21 and the second-stage orifice plate 3 can be prevented. As a result, noise due to the air column resonance can be reduced.

### REFERENCE SIGNS LIST

1 pipe
2 first-stage orifice plate
3 second-stage orifice plate
5 flow path
6-i hole
7-i t flow
8-i hole
10 multistage pressure reduction device
11 first-stage orifice plate
12-i hole
20 multistage pressure reduction device
21 first-stage orifice plate
22 cylinder
23 support member
24 hole
25-i hole
26-i jet flow

1-6. (canceled)

7. A multistage pressure reduction device comprising:
a pipe forming a flow path;
an upstream orifice plate disposed in the flow path; and
a downstream orifice plate disposed downstream of the upstream orifice plate in the flow path,
wherein the upstream orifice plate is formed with a plurality of holes, each hole being formed along a corresponding one of a plurality of lines perpendicular to a plane of the upstream orifice plate, and
the holes are close to each other such that a plurality of jet flows discharged respectively from the holes contact each other.

8. The multistage pressure reduction device of claim 7, wherein
the hole is formed in a polygonal shape.

9. The multistage pressure reduction device of claim 7, wherein
an opening area of the plurality of holes of the downstream orifice plate is larger than an opening area of the plurality of the holes of the upstream orifice plate.

10. The multistage pressure reduction device of claim 7, wherein
the plurality of the holes of the upstream orifice plate are formed such that a distance between centers of adjacent ones of the holes is equal to or longer than 1d, where d denotes a diameter of each hole.

11. A boiler comprising:
the multistage pressure reduction device of claim 7; and
a burner configured to burn fuel whose pressure is reduced by the multistage pressure reduction device.
